(19) United States
(12) Patent Application Publication
(10) Pub. No.: US 2013/0042702 A1
(43) Pub. Date: Feb. 21, 2013

(54) FORCE SENSOR AND MEASURING METHOD OF RESISTANCE VARIATION THEREOF

(71) Applicants: Chia-Sheng Huang, Yilan County (TW); Yan-Rung Lin, Hsinchu City (TW); Chang-Ho Liou, Changhua County (TW)

(72) Inventors: Chia-Sheng Huang, Yilan County (TW); Yan-Rung Lin, Hsinchu City (TW); Chang-Ho Liou, Changhua County (TW)

(73) Assignee: INDUSTRIAL TECHNOLOGY RESEARCH INSTITUTE, Hsinchu (TW)

(21) Appl. No.: 13/304,696

(22) Filed: Nov. 28, 2011

(30) Foreign Application Priority Data
Aug. 19, 2011 (TW) 100129754

(51) Int. Cl. G01L 1/18

(52) U.S. Cl. 73/862.625

(57) ABSTRACT

A force sensor and a measuring method of resistance variation thereof are provided. The force sensor includes a first substrate, multiple first electrodes, a second substrate, multiple second electrodes, and a piezoresistive layer. The first electrodes are disposed on the first substrate while the second electrodes facing the first electrodes are disposed on the second substrate. The multiple second electrodes are electrically isolated to each other. Orthogonal projections of the two adjacent second electrodes respectively overlap the corresponding first electrode. The piezoresistive layer is located between the first and the second electrodes and disposed on at least one kind of the first and the second electrodes.

### CROSS-REFERENCE TO RELATED APPLICATION

This application claims the priority benefit of Taiwan application serial no. 100129754, filed Aug. 19, 2011. The entirety of the above-mentioned patent application is hereby incorporated by reference herein and made a part of this specification.

### BACKGROUND OF THE INVENTION

1. Field of the Invention

The disclosure relates to a force sensor and a measuring method thereof.

2. Description of Related Art

In the conventional force sensor design, the input and output terminals are distributed on the different substrates, so that the non-coplanar terminals of the force sensor need to be disposed onto the same plane through a conductive adhesive or a pin clamping process to make the terminals coplanar for the measurement facilitation and utilization.

FIG. 1 is a schematic exploded view illustrating a conventional force sensor in which a conductive adhesive is used. Referring to FIG. 1, the measuring method of the force sensor 100 is that, the sensing units 132, 142 are pressured together to obtain the correlation between force and resistance (or conductance). Herein the sensing unit 142 located at the lower substrate 120 is connected to the terminal 150 of the force sensor 100 through the lead 140, the sensing unit 132 located at the upper substrate 110 is connected to the terminal 134 through the lead 130. In addition, it is further necessary to transfer the terminal 134 located at the upper substrate 110 into the connecting terminal 160 located at the lower substrate 120 by using the conductive adhesive, and the connecting terminal 160 is connected to the terminal 180 of the force sensor 100 through the connecting lead 170, so that the electrodes of the force sensor terminals are disposed coplanarly.

As for the above mentioned connecting method for making the terminals coplanar by using the conductive adhesive, it may lead to the damage of conductive adhesive during the repeatedly deflection or excessively bending of the substrate 110 or substrate 120, and it may further lead to the force sensor 100 unavailable.

FIG. 2 is a schematic view of a force sensor and a flexible printed circuit board connector. Referring to FIG. 2, as to the connecting method for making the terminals coplanar by using the pin clamping process, the pitch between the connecting terminals of the commercial force sensor 200 is 2.54 mm, and the pitch between the connecting pins of the connector 212 of the flexible printed circuit board 210 is 0.5 mm. Thus, the terminals of the force sensor 200 is restricted due to being unable to effectively reduce its terminal size to connect with the connector 212, and accordingly the application range of the force sensor 200 is limited.

FIG. 3A and FIG. 3B are schematic partial cross-sectional views of a conventional force sensor. Please refer to FIG. 3A and FIG. 3B together. When a force is applied, the piezoresistive layer 132a of the sensing unit 132 contacts with the piezoresistive layer 142a of the sensing unit 142 to generate the variation of electrical resistance. Thus, if the exerting force is non-uniform distributed on the sensor surface 110 as shown in FIG. 3B, the inner current path of piezoresistive layer will be affected and the inaccurate measurement of resistance value is further resulted. Additionally, if the well mixed piezoresistive material is not selected, the error of the measured resistance may become larger.

To solve the above problems, the objective of the disclosure is to propose a force sensor with coplanar design of the input and output terminal structures.

### SUMMARY OF THE INVENTION

The disclosure provides a force sensor with a coplanar terminal design in which the input terminal and the output terminal are disposed on the same plane.

The disclosure provides a measuring method of resistance variation of a force sensor which is different from the related art thereof.

According to the objects mentioned above, the disclosure provides a force sensor including a first substrate, N first electrodes, a second substrate, N+1 second electrodes and a piezoresistive layer. The first electrodes are disposed on the first substrate, wherein N is a positive integer. The second electrodes faced the first electrodes are electrically isolated from each other and disposed on the second substrate. Furthermore, portions of the orthogonal projections of the N^{th} and (N+1)^{th} second electrodes are respectively overlapped with the corresponding N^{th} first electrode. The piezoresistive layer is located between the first electrodes and the second electrodes, and disposed on at least one kind of the first electrodes and the second electrodes. As an external force is applied to the force sensor, the second electrodes are conducted to the corresponding first electrodes through the piezoresistive layer, and a plurality of sub resistance variations is generated. Thus, the total resistance variation of the force sensor is obtained from the sum of sub resistance variations.

Several exemplary embodiments accompanied with figures are described in detail below to further describe the disclosure in details.

### BRIEF DESCRIPTION OF THE DRAWINGS

The accompanying drawings constituting a part of this specification are incorporated herein to provide a further understanding of the invention. Here, the drawings illustrate embodiments of the invention and, together with the description, serve to explain the principles of the invention.

FIG. 1 is a schematic exploded view illustrating a conventional force sensor in which a conductive adhesive is used.

FIG. 2 is a schematic view of a force sensor and a flexible printed circuit board connector.

FIGS. 3A and 3B are schematic partial cross-sectional views of a conventional force sensor.

FIG. 4 is a schematic view of a force sensor according to an embodiment of the disclosure.

FIG. 5 is an exploded schematic view of the force sensor in FIG. 4.

FIG. 6 is a schematic cross-sectional view along Line A-A in FIG. 4.

FIG. 7 is a schematic view of the circuit path of the force sensor in FIG. 6 after being conducted due to the applied force.

FIG. 8 is an equivalent circuit diagram of FIG. 7.

FIG. 9 is a schematic view of a force sensor according to another embodiment of the disclosure.

FIG. 10 is a schematic view of the circuit loop of the force sensor in FIG. 9 after being assembled and conducted due to the applied force.

FIG. 11A is an exploded schematic view of a force sensor according to another embodiment of the disclosure.

FIG. 11B is a schematic view of the force sensor in FIG. 11A after being assembled.

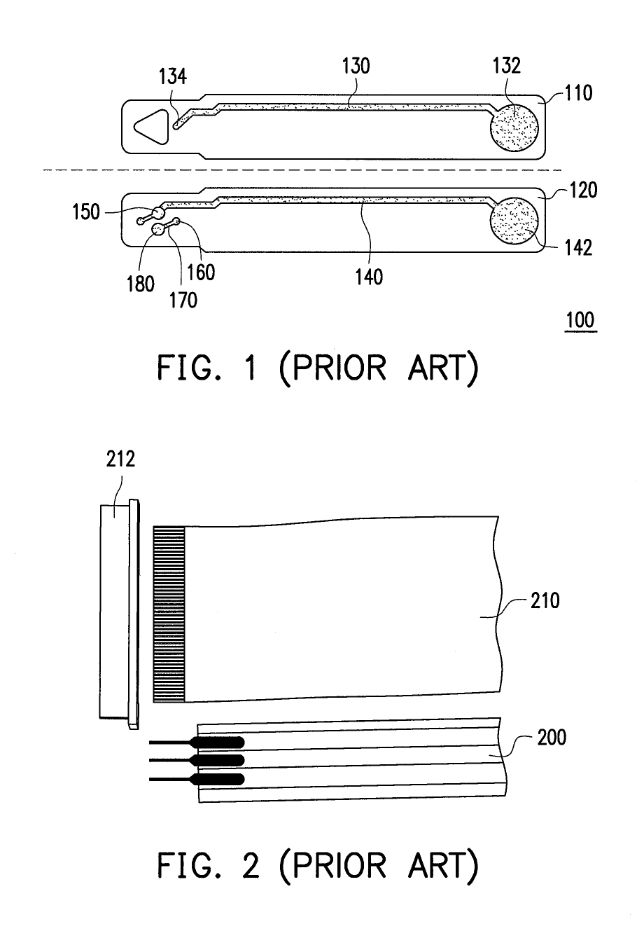

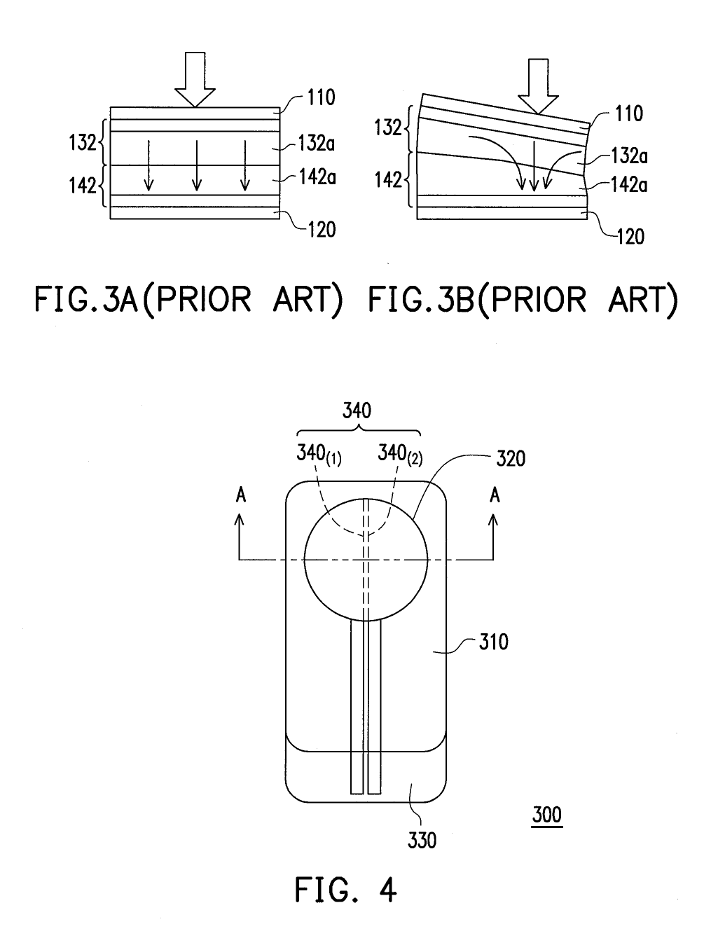

### DESCRIPTION OF EMBODIMENTS

An embodiment provides a force sensor. The force sensor of the disclosure has input and output terminals disposed on a same plane. Compared to conventional force sensors, the force sensor of the disclosure has an additional advantage of being capable of reducing the measurement errors derived from non-uniformly distributed forces and from poorly mixed piezoresistive materials. Moreover, the input and output terminals of the force sensor directly disposed on the same plane of a same substrate can simplify the lead layout and minimize the terminal size and pitch. In addition, the electrodes of the force sensor of the embodiment are designed in multi-subsection structure. For example, the number of electrodes disposed on the upper substrate is N, and the number of electrodes disposed on the lower substrate is N+1. Herein N is a positive integer. The electrodes on the upper substrate are electrically isolated from each other, and the electrodes on the lower substrate are also electrically isolated from each other. In addition, each of the orthogonal projections of the electrodes on the upper substrate projected onto the lower substrate is overlapped with a portion of the corresponding electrode on the lower substrate. Therefore, when the force sensor is compressed, the electrodes located on the upper and lower substrate will make contact with each other and thus will be conducted to form a loop. And an equivalent resistance variation of the force sensor is measured by the means of resistance variations from the piezoresistive layer between the electrodes. Herein the equivalent resistance variation of the force sensor is obtained by the sum of the sub resistance variations from the piezoresistive layer between the electrodes after each of the electrodes are conducted. Each of the sub resistance variations may be different due to the different contact areas or the deformation of volume of the piezoresistive material. Thus, the sub resistance variations can be more accurate compared to the conventional measuring method, and thus a comparatively more accurate equivalent resistance variation can further be obtained. The structure and an application of the force sensor for measuring equivalent resistance variations are described as follows.

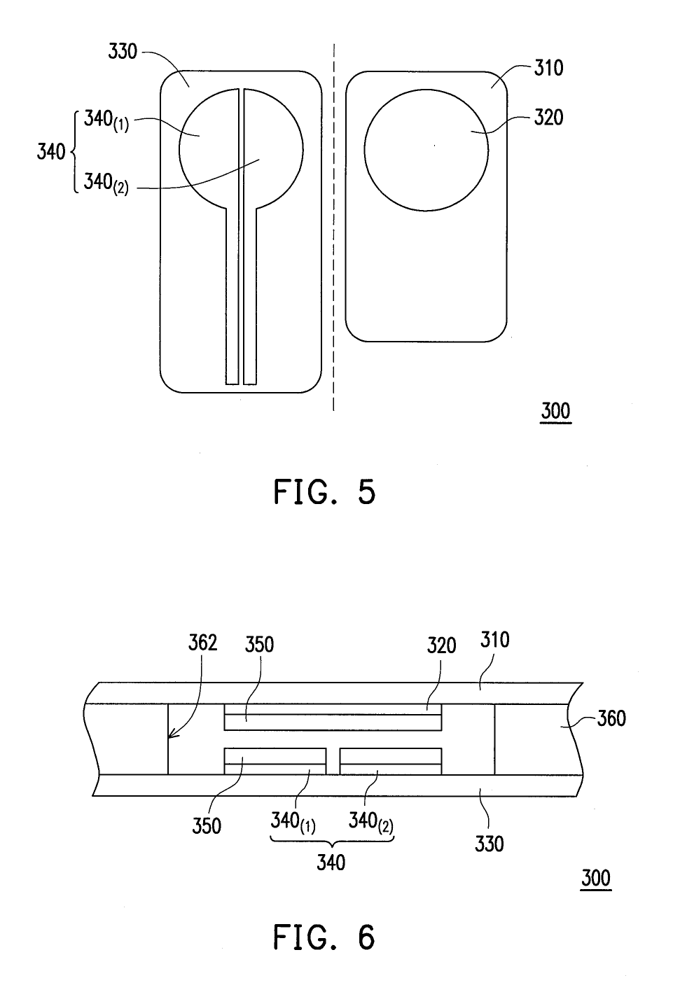

FIG. 4 is a schematic view of the force sensor according to an embodiment of the disclosure. FIG. 5 is an exploded schematic view of the force sensor in FIG. 4. FIG. 6 is a schematic cross-sectional view along Line A-A in FIG. 4. Referring to FIG. 4, FIG. 5 and FIG. 6 together, the force sensor 300 of the embodiment includes a first substrate 310, a first electrode 320, a second substrate 330, two second electrodes 340 and a piezoresistive layer 350. The first electrode 320 is disposed on the first substrate 310. The second electrodes 340 facing the first electrode 320 are disposed on the second substrate 330. The piezoresistive layer 350 is located between the first electrode 320 and the second electrodes 340 and is disposed on at least one kind of the first electrode 320 and the second electrodes 340.

As described above, the first substrate 310 and the second substrate 330 are flexible substrates, printed circuit boards or a combination of a flexible substrate and a printed circuit board in the embodiment. The two second electrodes 340 disposed on the second substrate 330 are electrically isolated from each other. Herein for the convenience of description, the two second electrodes 340 are respectively described as the second electrode 340₍₁₎ and the second electrode 340₍₂₎. The electrical isolation between the second electrode 340₍₁₎ and the second electrode 340₍₂₎ means that, the second electrode 340₍₁₎ and the second electrode 340₍₂₎ are not physically in contact with each other, so that they are physically separated entirely.

The first electrode 320 and the second electrodes 340 can be formed by metal, conductive metal oxide, conductive polymer, or conductive carbon material. And the first electrode 320 and the second electrodes 340 are formed by a screen printing process, a coating process, an etching process, an inkjet process, or a transfer printing process on the corresponding first substrate 310 and the corresponding second substrate 330. The shapes of the first electrode 320 and the second electrodes 340 are not limited and can be changed as required. As shown here, the first electrode 320 of the embodiment is a circular form, and the second electrodes 340 are semi-circle shapes and arranged to be a circular form. In addition, leads and terminals (not shown) for input and output current connecting with the second electrodes 340 are disposed on the second substrate 330. The layout of the leads is not a key point of the disclosure, and therefore it will not be described in detail.

Particularly, when the first substrate 310 and the second substrate 330 are overlapped with each other, a portion of the orthogonal projection of the second electrode 340₍₁₎ may overlap with the corresponding first electrode 320, and a portion of the orthogonal projection of the second electrode 340₍₂₎ may also overlap with the corresponding first electrode 320, but the orthogonal projections of the second electrode 340₍₁₎ and the second electrode 340₍₂₎ are not overlapped with each other.

Additionally, a piezoresistive layer 350 is disposed on both the first electrode 320 and the second electrodes 340. But in other embodiments not shown in figures, the piezoresistive layer 350 can be merely disposed on the first electrode 320 or merely disposed on the second substrates 340, so that it can be changed as required. Besides, the piezoresistive layer 350 can be formed by a screen printing process, an inkjet process, or a transfer printing process.

The force sensor 300 further includes a supporting body 360 disposed between the first substrate 310 and the second substrate 330. And gap 362 may exist between the supporting body 360 and the first electrode 320, and between the supporting body 360 and the second electrodes 340. In other embodiments not shown in figures, the supporting body 360 can be directly in contact with the first electrode 320 and the second electrodes 340, and therefore no gap is disposed in between. The supporting body 360 can be used to fix the distance between the first substrate 310 and the second substrate 330, so as to prevent the first substrate 310 and the second substrate 330 from being conducted through the piezoresistive layer 350 due to the first substrate 310 and the second substrate 330 being too close before the external force is exerted. The piezoresistive layer 360 can be an adhesive or a double sided tape formed by a screen printing process, an inkjet process, or a transfer printing process.

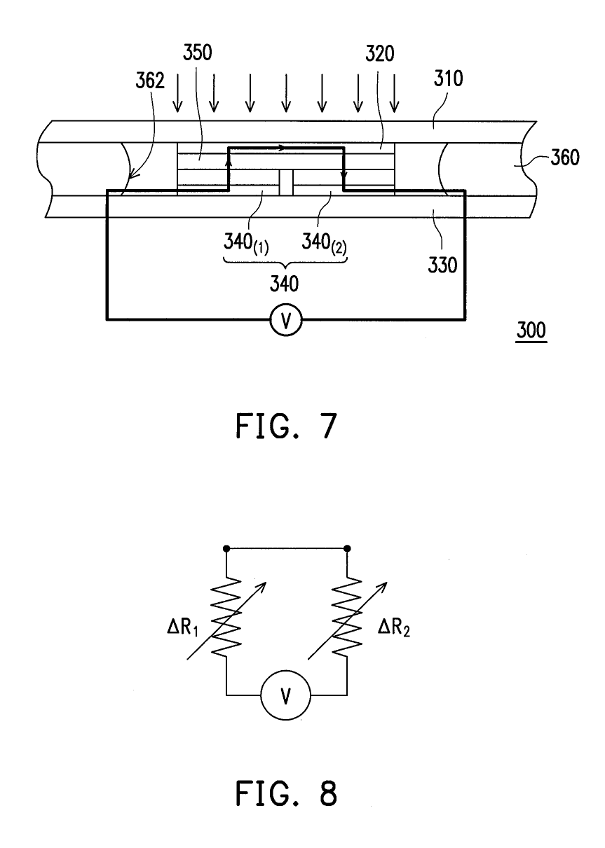

FIG. 7 is a schematic view of the circuit path of the force sensor in FIG. 6 after conducted due to the applied force. FIG. 8 is an equivalent circuit diagram of FIG. 7. Please refer to FIG. 4, FIG. 7 and FIG. 8 together. When an external force is applied to the force sensor 300 on a wrong place where the applied force is exerted, the first electrode 320 and the second electrodes 340 will not be conducted to form a circuit loop. The wrong place where the applied force is exerted on may be a place beyond the corresponding first electrode 320 and the second electrodes 340, or a place where the second electrode 340₍₁₎ or the second electrode 340₍₂₎ is located.

When a force is applied to the force sensor 300 on a correct place where the applied force is exerted, piezoresistive layers 350 on the first electrode 320 and the second electrode 340₍₁₎, 340₍₂₎ are simultaneously in contact with each other and conducted, and then a loop is generated. Herein since the second electrode 340₍₁₎ can accept an external current and transmit the current to the second electrode 340₍₂₎ through the first electrode 320 simultaneously, the second electrode 340₍₁₎ has the functions as both input and output terminals, so as the second electrode 340₍₂₎. At this moment, the first electrode 320 and the second electrode 340₍₁₎ are conducted, and a sub resistance variation ΔR₁ is generated; the first electrode 320 and the second electrode 340₍₂₎ are conducted, and a sub resistance variation ΔR₂ is generated; and then, the equivalent resistance variation ΔR of the force sensor 300 can be obtained by summing up the values of ΔR₁ and ΔR₂. Thus, through the disposing of the first electrode 320 and the second electrodes 340 and the generated loop, the following equation can be obtained:

ΔR=ΔR₁+ΔR₂

Though it is theoretically supposed that the applied force exerted to the force sensor 300 can be a uniform distributed force to achieve a good measuring result, in practical situation there are unexpected factors that may affect the applied force to be non-uniform. As described above, since subsection design is used in the second electrodes 340 of the force sensor 300 of the embodiment, when the second electrodes 340₍₁₎, 340₍₂₎ and the first electrode 320 are respectively conducted, the individual sub resistance variation ΔR₁, ΔR₂ may be correspondingly different due to the different conductive contact areas between the second electrodes 340₍₁₎, 340₍₂₎ and the piezoresistive layer 350 of the corresponding first electrode 320 (when the piezoresistive layer 350 is disposed on both the first electrode 320 and the second electrodes 340), or between the piezoresistive layer 350, the second electrodes 340₍₁₎, 340₍₂₎ and the corresponding first electrode 320 (it depends on if the piezoresistive layer 350 is disposed on the second electrodes 340 or the first electrode 320), and the larger the contact area is, the larger the sub resistance variation ΔR₁ or ΔR₂ may become. Alternatively, the volume deformation of the piezoresistive layer 350 located between the first and second electrodes may lead to the generation of the sub resistance variation ΔR₁ or ΔR₂; and the larger the deformation is, the larger the sub resistance variation ΔR₁ or ΔR₂ may become. Therefore, the sub resistance variation ΔR₁ or ΔR₂ may vary with the contact area or the volume deformation of the piezoresistive layer 350. The selected piezoresistive material will define the characteristic of resistance variation derived by the contact area or volume deformation. And since an accurate contact can be obtained after the force is applied, the linear correlation between the conductance and the force is better so that the measured equivalent resistance variation ΔR of the force sensor can become more accurate.

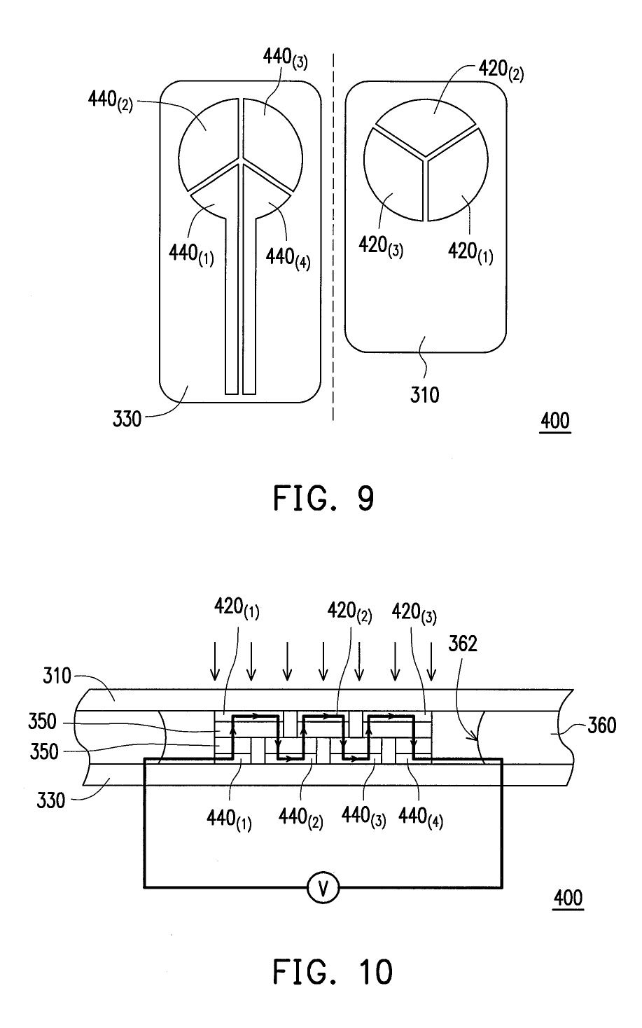

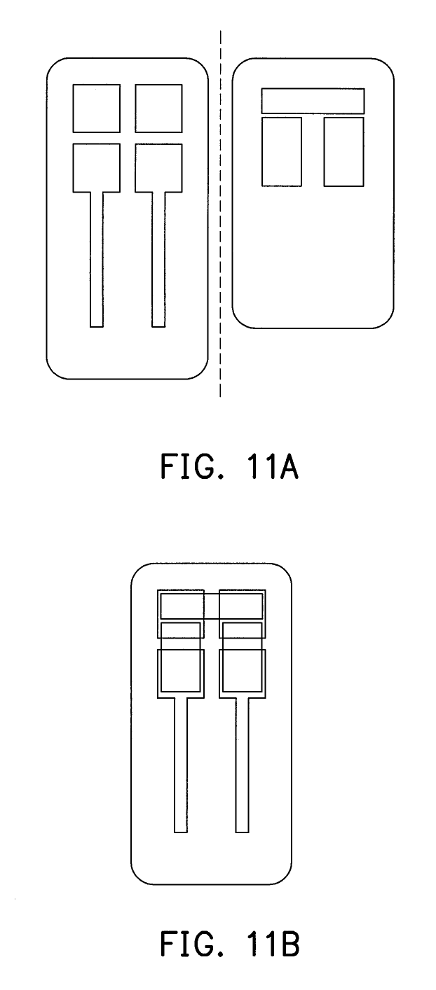

FIG. 9 is a schematic view of a force sensor according to another embodiment of the disclosure. FIG. 10 is a schematic view of the circuit loop of the force sensor in FIG. 9 after being assembled and conducted due to the applied force. Referring to FIG. 9 and FIG. 10 together, the first electrodes are three and the second electrodes are four in the embodiment. For the convenience of description, the three first electrodes 420 are respectively described as the first electrode 420₍₁₎, the first electrode 420₍₂₎, and the first electrode 420₍₃₎; and correspondingly, the four second electrodes 440 are respectively described as the second electrode 440₍₁₎, the second electrode 440₍₂₎, the second electrode 440₍₃₎ and the second electrode 440₍₄₎. The first electrode 420₍₁₎, the first electrode 420₍₂₎, the first electrode 420₍₃₎ and the second electrode 440₍₁₎, the second electrode 440₍₂₎, the second electrode 440₍₃₎ the second electrode 440₍₄₎ are in a fan-shaped individually and respectively arranged on the first substrate 310 and the second substrate 330 in a circular form.

It should be noted that, taking the dash-line in FIG. 9 as the symmetrical fold line, for example the first substrate 310 is folded from the right side of FIG. 9 to the left side so that when the first substrate 310 is overlapped with the second substrate 330, the orthogonal projection of the second electrode 440₍₄₎ will not be overlapped with the first electrode 420₍₁₎ in order to prevent the second electrode 440₍₄₎ and the first electrode 420₍₁₎ from being conducted; otherwise a complete sensing loop cannot be formed for the force sensor 400 among the second electrode 440₍₁₎, the first electrode 420₍₁₎, the second electrode 440₍₂₎, the first electrode 420₍₂₎, the second electrode 440₍₃₎, the first electrode 420₍₃₎, and the second electrode 440₍₄₎.

Similarly, when a force is applied to the force sensor 400, the first electrode 420₍₁₎, the first electrode 420₍₂₎ and the first electrode 420₍₃₎ are respectively conducted with the second electrode 440₍₁₎, the second electrode 440₍₂₎, the second electrode 440₍₃₎ and the second electrode 440₍₄₎ through the piezoresistive layer 350, and thus the current flows from the second electrode 440₍₁₎ and then subsequently passes through the first electrode 420₍₁₎, the second electrode 440₍₂₎, the first electrode 420₍₂₎, the second electrode 440₍₃₎, the first electrode 420₍₃₎ and the second electrode 440₍₄₎ to form a loop; and then the equivalent resistance variation of the force sensor 400 can be obtained as follows:

ΔR=ΔR₁+ΔR₂+ΔR₃+ΔR₄+ΔR₅+ΔR₆

As in the two embodiments described above, when there are N first electrodes, then there are N+1 second electrodes. Herein when N is a positive integer and greater than 1, the plurality of first electrodes located on the same substrate are electrically isolated from each other, and the plurality of second electrodes located on another substrate are also electrically isolated from each other. In addition, the orthogonal projection of the (N+1)^{th} second electrode is not overlapped with the 1^{st} first electrode. And the equation for the total resistance variation of the force sensor is as follows:

ΔR=ΔR₁+ΔR₂+ . . . +ΔR_{2N}

FIG. 11A is an exploded schematic view of a force sensor according to another embodiment of the disclosure. FIG. 11B is a schematic view of the force sensor in FIG. 11A after being assembled. The difference of the present embodiment between the above two embodiments is that, the first electrodes and the second electrodes of this embodiment are rectangular shapes. And the structural configuration, the measuring method and the effect are similar to the above two embodiments, the detailed description thereof is not repeated.

In light of the foregoing, the second electrodes having both input and output current functions are disposed on the same plane of the lower substrate in the force sensor of the disclosure, and thus the force sensor of the disclosure is different from the structure of the conventional force sensor. In addition, since the electrodes are designed in multi-subsections, the sub resistance variations generated after the electrodes being conducted to each other may vary with the contact area or the volume deformation of the piezoresistive layer located between the corresponding first and second electrodes. And the equivalent resistance variation of the force sensor is the sum of the sub resistance variations. Thus, in the application of the force sensor to measure the resistance variation, it can be deemed as the sum of measurement of a plurality of small force sensors. Therefore, the force sensor having a proportional and linear correlation between the conductance and the force of the disclosure is more accurate, and unlike the conventional single force sensor in which the measured resistance variation may have a larger error due to the non-uniform distributed force.

Although the invention has been described with reference to the above embodiments, it will be apparent to one of the ordinary skill in the art that modifications to the described embodiment may be made without departing from the spirit of the invention. Accordingly, the scope of the invention will be defined by the attached claims not by the above detailed descriptions.

What is claimed is:

1. A force sensor, comprising:
a first substrate;
N first electrodes disposed on the first substrate, wherein N is a positive integer;
a second substrate;
N+1 second electrodes disposed on the second substrate, and the N+1 second electrodes facing the N first electrodes, wherein the N+1 second electrodes are electrically isolated from each other, and a portion of the orthogonal projection of the N^{th} second electrode and a portion of the orthogonal projection of the (N+1)^{th} second electrode are respectively overlapped with the corresponding N^{th} first electrode; and
a piezoresistive layer located between the N first electrodes and the N+1 second electrodes, and disposed on at least one kind of the N first electrodes and the N+1 second electrodes,
wherein when an external force is applied to the force sensor, the N+1 second electrodes are conducted to the corresponding N first electrodes through the piezoresistive layer, and a plurality of sub resistance variations are generated, and a total resistance variation of the force sensor is obtained from the sum of the sub resistance variations.

2. The force sensor as claimed in claim 1, wherein the first substrate is a flexible substrate or a printed circuit board, and the second substrate is a flexible substrate or a printed circuit board.

3. The force sensor as claimed in claim 1, wherein when N is greater than 1, the first electrodes are electrically isolated from each other.

4. The force sensor as claimed in claim 3, wherein the orthogonal projection of the (N+1)^{th} second electrode is not overlapped with the 1^{st} first electrode.

5. The force sensor as claimed in claim 1, wherein the N first electrodes and the N+1 second electrodes are made of metal, conductive metal oxide, conductive polymer or conductive carbon material.

6. The force sensor as claimed in claim 1, wherein the N first electrodes and the N+1 second electrodes are formed by a screen printing process, a coating process, an etching process, an inkjet process or a transfer printing process.

7. The force sensor as claimed in claim 1, wherein the piezoresistive layer is formed by a screen printing process, an inkjet process or a transfer printing process.

8. The force sensor as claimed in claim 1, further comprising a supporting body disposed between the first substrate and the second substrate.

9. The force sensor as claimed in claim 8, wherein a gap exists between the supporting body and the N first electrodes, the N+1 second electrodes.

10. A measuring method of resistance variation of a force sensor, comprising:
providing a force sensor, wherein the force sensor comprises N first electrodes, N+1 second electrodes and a piezoresistive layer, N is a positive integer, and the a portion of the orthogonal projection of N^{th} second electrode and a portion of the orthogonal projection of the (N+1)^{th} second electrode are respectively overlapped with the corresponding N^{th} first electrode; wherein the piezoresistive layer is located between the N first electrodes and the N+1 second electrodes, and disposed on at least one kind of the N first electrodes and the N+1 second electrodes;
compressing the force sensor, wherein the second electrodes which are exerted by an external force are conducted to the corresponding first electrodes, and a plurality of sub resistance variations are generated; and
summing up the sub resistance variations to obtain the total resistance variation of the force sensor.

11. The measuring method of resistance variation of a force sensor as claimed in claim 10, wherein not all of the sub resistance variations are equal.

12. The measuring method of resistance variation of a force sensor as claimed in claim 11, wherein when the force sensor is compressed, the piezoresistive layer disposed on the first electrodes contacts with the corresponding piezoresistive layer disposed on the corresponding second electrodes due to the exerted force, or the piezoresistive layer contacts with either the first electrodes or the second electrodes corresponding to the orthogonal projection of the piezoresistive layer due to the exerted force, wherein the larger the contact area, the larger the sub resistance variation.

13. The measuring method of resistance variation of a force sensor as claimed in claim 11, wherein when the force sensor is compressed, the piezoresistive layer is deformed due to the exerted force, and the larger the deformation of the piezoresistive layer, the larger the sub resistance variation.
